(19) United States
(12) Patent Application Publication
(10) Pub. No.: US 2013/0224543 A1
(43) Pub. Date: Aug. 29, 2013

(54) CATHODE FOR LITHIUM BATTERY WITH EXCELLENT OUTPUT PROPERTIES, METHOD OF MANUFACTURING THE CATHODE AND LITHIUM BATTERY USING THE SAME

(71) Applicants: Sang-Sun PARK, Yesan-gun (KR); Yong-Jun PARK, Seoul (KR); A-Ram CHOI, Cheonan-si (KR); Bum-Soo KIM, Cheonan-si (KR)

(72) Inventors: Sang-Sun PARK, Yesan-gun (KR); Yong-Jun PARK, Seoul (KR); A-Ram CHOI, Cheonan-si (KR); Bum-Soo KIM, Cheonan-si (KR)

(73) Assignee: VITZROCELL CO., LTD., Seoul (KR)

(21) Appl. No.: 13/446,387

(22) Filed: Apr. 13, 2012

(30) Foreign Application Priority Data
Feb. 27, 2012 (KR) 10-2012-0019905

(51) Int. Cl. H01M 4/64; H01M 2/30; H01M 4/04; H01M 4/00

(52) U.S. Cl. 429/94; 429/211; 429/178; 29/623.1

(57) ABSTRACT

The present disclosure provides a cathode for lithium batteries with a structure suited to high output properties, a method of manufacturing the same, and a lithium battery using the same. The cathode has a stack structure including a first cathode member, a separating member and a second cathode member stacked in sequence to have a pipe shape or a folded shape with spaced ends, wherein each of the first and second cathode members includes a current collector and a cathode active material formed on either side of the current collector.

### CROSS-REFERENCE TO RELATED APPLICATION

This application claims the benefit under 35 U.S.C. §119 of Korean Patent Application No. 10-2012-0019905, filed on Feb. 27, 2012 in the Korean Intellectual Property Office, the entirety of which disclosure is incorporated herein by reference.

### BACKGROUND

1. Technical Field

The present invention relates to lithium batteries, and more particularly, to a cathode for lithium batteries with a structure having excellent output properties through an enlarged surface area of a cathode active material, and a lithium battery using the same.

2. Description of the Related Art

A lithium battery refers to a battery that uses a lithium component such as lithium or a lithium alloy as an anode material.

Such lithium batteries have higher power and higher capacity than existing manganese batteries and are widely used as power sources for various electronic appliances.

FIG. 1 schematically shows a general lithium battery.

Referring to FIG. 1, the lithium battery includes a case 110 open at top thereof, an anode 120, a separator 130, a cathode 140 and a terminal part 150a, 150b, 150c.

The anode 120 is disposed on an inner wall of the case 110 and containing a lithium component.

The separator 130 is disposed inside the anode 120 and separates the anode 120 from the cathode 140.

The cathode 140 is disposed inside the separator 130 and includes a current collector 145 and a cathode active material.

The terminal part includes an anode terminal 150a and a cathode terminal 150b which are insulated from each other by an insulator 150c. Generally, the anode terminal 150a is connected to the anode through the case 110. The cathode terminal 150b is connected to the current collector 145 of the cathode 140 through a lead wire 160.

In the lithium battery shown in FIG. 1, the terminal part serves as a cap for covering the top of the case. In this case, an insulating plate 170 is provided to insulate the terminal part from elements inside the case. The insulating plate 170 may be made of fluorinated ethylene propylene (FEP) or the like.

FIG. 2 is a schematic view of one example of a conventional cathode for lithium batteries.

Referring to FIG. 2, the cathode 200 for lithium batteries includes a current collector 210, and a cathode active material 220 coupled to the current collector 210 to surround the current collector 210.

However, in a cathode structure as shown in FIG. 2, the cathode active material 220 has a small surface area as compared with its volume. Thus, electrochemical reaction occurs only on a half region 225 of the surface area of the cathode active material 220 in operation of the lithium battery. As a result, the cathode structure shown in FIG. 2 has limited output power.

Various attempts have been made to increase the surface area of the cathode active material 220.

FIG. 3 is a schematic view of another example of a conventional cathode for lithium batteries.

In a cathode 300 for lithium batteries shown in FIG. 3, cathode active materials 310a, 310b are separated from each other while being coupled to a current collector 320.

However, the cathode 300 does not improve output characteristics.

Korean Patent Publication No. 10-2011-0106506 (published on Sep. 29, 2011) discloses such a conventional lithium battery.

### BRIEF SUMMARY

The present invention provides a cathode for lithium batteries having a structure capable of outputting high power.

In addition, the present invention provides a method of manufacturing a cathode for lithium batteries.

Further, the present invention provides a lithium battery including such a cathode.

In accordance with one aspect of the present invention, a cathode for lithium batteries has a stack structure including a first cathode member, a separating member and a second cathode member stacked in sequence, wherein each of the first and second cathode members includes a current collector and a cathode active material formed on either side of the current collector.

The first cathode member may have a pipe shape; the separating member may be formed on an outer periphery of the first cathode member; and the second cathode member may be formed on an outer periphery of the separating member.

The first cathode member may include a first cathode sheet including a current collector and a cathode active material formed on either side of the current collector; the separating member may include a separator sheet; and the second cathode member may include a second cathode sheet including a current collector and a cathode active material formed on either side of the current collector. Both ends of the stack structure may be joined to each other to form a pipe shape.

The stack structure may be folded so that both ends of the stack structure are spaced from each other.

The stack structure may be folded in a “⊂” or “C” shape.

In accordance with another aspect of the present invention, there is provided a method of manufacturing a cathode for lithium batteries, wherein the cathode has a stack structure including a first cathode member, a separating member and a second cathode member stacked in sequence, and each of the first and second cathode members includes a current collector and a cathode active material formed on either side of the current collector.

The method may include: preparing a first cathode sheet, a separator sheet, and a second cathode sheet; preparing a first cathode sheet, a separator sheet, and a second cathode sheet; joining both ends of the first cathode sheet to each other to form a first cathode member having a pipe shape; attaching the separator sheet to an outer periphery of the first cathode member to form a separating member; and attaching the second cathode sheet to an outer periphery of the separating member to form a second cathode member, wherein each of the first and second cathode sheets comprises a current collector and a cathode active material formed on either side of the current collector.

Alternatively, the method may include: preparing a first cathode sheet, a separator sheet, and a second cathode sheet; sequentially stacking the separator sheet and the second cathode sheet on the first cathode sheet to form the stack structure; and joining both ends of the stack structure to form a pipe shape, wherein each of the first and second cathode sheets includes a current collector and a cathode active material formed on either side of the current collector.

In accordance with a further aspect of the present invention, a lithium battery includes: a case; an anode disposed on an inner wall of the case and containing a lithium component; a separator disposed inside the anode; a cathode disposed inside the separator; an anode terminal electrically connected to the anode; a cathode terminal electrically connected to the cathode; and an electrolyte filling the case, wherein the cathode has a stack structure including two cathode members stacked on a separating member interposed between the two cathode members, and each of the cathode members comprises a current collector and a cathode active material formed on either side of the current collector.

The cathode may have a pipe shape with both ends thereof joined to each other or a folded shape with both ends thereof spaced from each other.

As described above, the cathode for lithium batteries according to the present invention has a stack structure wherein two cathode members are stacked on a separating member interposed therebetween. Also, each of the two cathode members has a structure where cathode active materials are formed on both sides of the current collector.

With these features, the cathode for lithium batteries according to the present invention has an effect of substantially increasing the surface area, such that electrochemical reaction may occur in all sides of the cathode active material.

Therefore, in a lithium battery using the cathode according to the present invention, electrochemical reaction may more actively occur than in the lithium battery using the conventional cathode structure, thereby providing high output properties in operation of the lithium battery.

### BRIEF DESCRIPTION OF THE DRAWINGS

The above and other aspects, features, and advantages of the invention will become apparent from the detailed description of the following embodiments in conjunction with the accompanying drawings, in which:

FIG. 1 is a schematic view of a general lithium battery;

FIG. 2 is a schematic view of one example of a conventional cathode for lithium batteries;

FIG. 3 is a schematic view of another example of the conventional cathode for lithium batteries;

FIG. 4 is a schematic plan view of a cathode for lithium batteries in accordance with one embodiment of the present invention; and

FIG. 5 is a schematic view of a stack structure in which a first cathode sheet, a separator sheet and a second cathode sheet are stacked.

### DETAILED DESCRIPTION

Embodiments of the invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. The scope of the invention is limited only by the accompanying claims and equivalents thereof. Like components will be denoted by like reference numerals throughout the specification.

Now, a cathode for lithium batteries with a structure having excellent output properties according to the present invention, and a lithium battery using the same will be described with reference to the accompanying drawings.

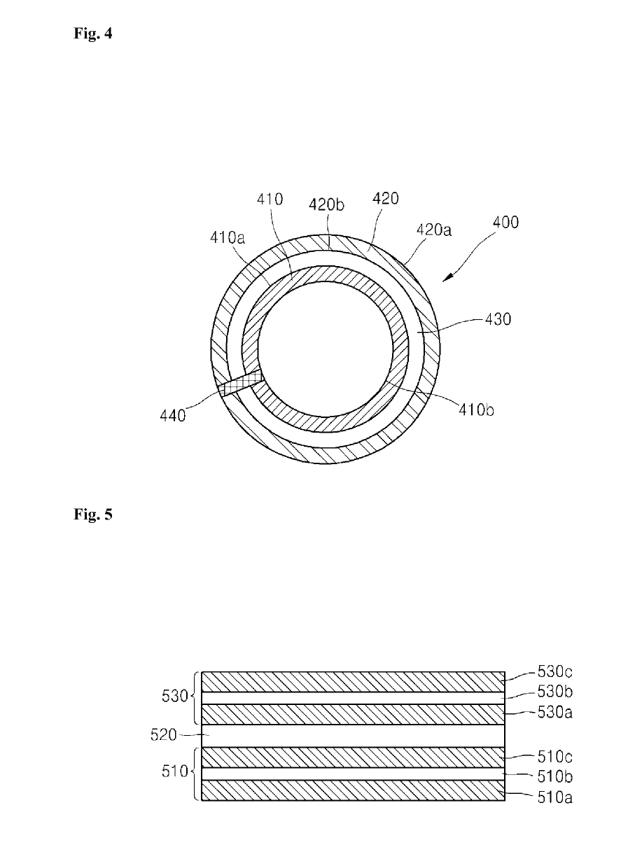

FIG. 4 is a schematic plan view of a cathode for lithium batteries in accordance with one embodiment of the present invention.

Referring to FIG. 4, a cathode 400 includes a first cathode member 410, a second cathode member 420, and a separating member 430.

The cathode for lithium batteries according to the present invention has various features. Particularly, two cathode members 410 and 420 are stacked with the separating member 430 interposed therebetween. In addition, each of two cathode members includes a current collector and cathode active materials formed on both sides of the current collector.

Such features of the cathode increase a surface area of the cathode active material on which electrochemical reaction may occur, thereby providing excellent output properties.

In addition, when the separating member 430 is formed as a porous insulator through which lithium ions can pass, electrochemical reaction can occur on all of four sides of the cathode active material, thereby providing excellent output properties.

Referring to FIG. 4, the first cathode member 410 has a pipe shape. Further, the separating member 430 is disposed on an outer periphery of the first cathode member 410. The second cathode member 420 is disposed on an outer periphery of the separating member 430.

Here, each of the first and second cathode members 410, 420 includes a current collector and a cathode active material formed on either side of the current collector.

The cathode structure as shown in FIG. 4 may be embodied by sequentially stacking the separating member and the second cathode member on the outer periphery of the first cathode member.

In addition, the cathode structure as shown in FIG. 4 may be embodied by a stack structure having a cross section as shown in FIG. 5.

Referring to FIG. 5, the stack structure includes a first cathode sheet 510, a separator sheet 520, and a second cathode sheet 530 which are sequentially stacked. Further, each of the first and second cathode sheets 510, 530 includes cathode active materials 510a, 510c; 530a, 530c formed on both sides of each current collector 510b, 530b by coating or the like.

When the sheets are wound such that both ends of the stack structure are joined to each other, the cathode of a pipe shape may be formed. Here, although the pipe shape of the cathode may be formed by winding the stack structure such that both ends of the stack structure exactly meet each other, the stack structure may be wound such that an upper surface of one end of the stack structure may be joined to a lower surface of the other end of the stack structure.

Both ends of the stack structure may be joined to each other in various ways, such as bonding agents, pressure application, pins or other coupling members, and the like.

Besides the pipe shape as shown in FIG. 4, the cathode for lithium batteries according to the present invention may have a structure in which both ends of the stack structure are spaced from each other by folding the stack structure of FIG. 5 in a certain form.

The folded shape may be determined depending on the shape of the battery case. Advantageously, the cathode active material may have an increased surface area when the stack structure is folded in a “⊂” or “C” shape.

Meanwhile, each current collector of the first and second cathode members 410, 420 may be made of a metal, such as nickel (Ni), copper (Cu), aluminum (Al), and alloys thereof, which exhibit excellent electrical conductivity. The current collector may be formed as a grid or the like.

In addition, the cathode active material formed on either side of the current collector may contain a carbon-based material such as active carbon or amorphous carbon, without being limited thereto.

In FIG. 4, the separating member 430 prevents a cathode active material surface 420b inside the second cathode member 420 from contacting a cathode active material surface 410a outside the first cathode member 410 in order to prevent a reduction in the surface area of the cathode active material. Further, the separating member 430 is configured to allow lithium ions to pass therethrough such that electrochemical reaction may occur not only on the exposed cathode active material surfaces 420a, 410b, but also on the cathode active material surfaces 420b, 410a contacting the separating member 430.

To this end, the separating member may be made of a porous insulator, which has electrically insulating properties and allows lithium ions to pass therethrough. In some embodiments, the separating member may be composed of at least one material selected from among micro glass fibers and long glass fibers.

Although FIG. 4 shows the cathode structure having a circular cross-section suited to a cylindrical lithium battery, the present invention is not limited thereto. In other words, the cathode according to the present invention may have various transverse sections, such as a triangular shape or the like, depending on the shape of the lithium battery.

The cathode for lithium batteries according to the present invention may be manufactured by various methods using the first cathode sheet, the separator sheet and the second cathode sheet.

First, one end of the first cathode sheet is joined to the other end thereof to form a first cathode member having a pipe shape, and the separator sheet is coupled to the outer periphery of the first cathode member to form a separating member having a pipe shape. Then, the second cathode sheet is coupled to the outer periphery of the separating member to form a second cathode member having a pipe shape.

In another embodiment, the separator sheet and the second cathode sheet are sequentially stacked on the first cathode sheet to form a stack structure having a longitudinal cross-section as shown in FIG. 5, and the stack structure is wound such that both ends of the stack structure are joined to each other to form a pipe shape.

In a further embodiment, the stack structure is formed to have a longitudinal cross-section as shown in FIG. 5, and then folded in a “⊂” or “C” shape such that both ends of the stack structure are spaced from each other.

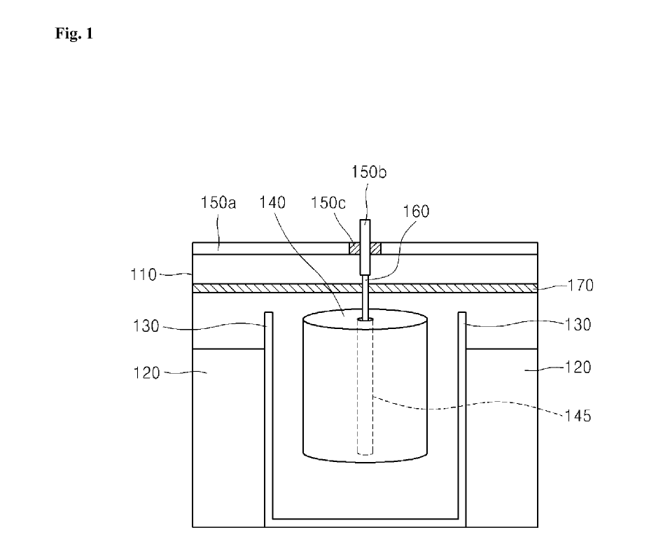

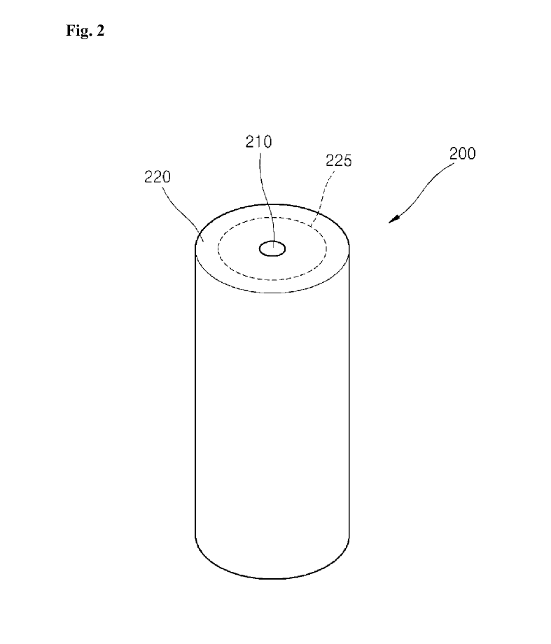

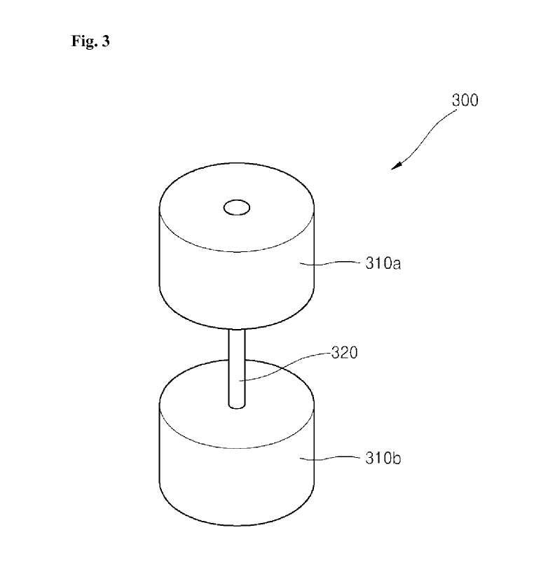

The cathode according to the present invention may be used for the lithium battery as shown in FIG. 1.

In this case, the lithium battery according to the present invention includes a case 110, an anode 120 disposed on an inner wall of the case 110 and containing a lithium component, a separator 130 disposed inside the anode 120, a cathode 140 disposed inside the separator 130, an anode terminal 150a electrically connected to the anode 120, a cathode terminal 150b electrically connected to the cathode 140, and an electrolyte (not shown) filling the case 110. The lithium battery according to the present invention may further include an insulating plate 170 as shown in FIG. 1.

At this time, the lithium battery according to the present invention has a structure wherein two cathode members are stacked on the separating member interposed therebetween. Here, each of the two cathode members may include a current collector and a cathode active material formed on either side of the current collector.

In operation of the battery, electrons generated by electrochemical reaction of the cathode active materials on the two cathode members are collected in the current collectors, and move to the cathode terminal 150b through the lead wire 160. The two current collectors and the cathode terminals may be connected in various ways. By way of example, the two current collectors and the cathode terminals may be connected via a lead wire and a lead wire connector 440 as shown in FIG. 4.

In the lithium battery having the cathode structure according to the present invention, electrochemical reaction occurs on all four sides of the cathode active material during operation of the battery, thereby providing excellent output properties.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A cathode for lithium batteries, the cathode having a stack structure including a first cathode member, a separating member and a second cathode member stacked in sequence,
wherein each of the first and second cathode members comprises a current collector and a cathode active material formed on either side of the current collector.

2. The cathode of claim 1, wherein
the first cathode member has a pipe shape;
the separating member is formed on an outer periphery of the first cathode member; and
the second cathode member is formed on an outer periphery of the separating member.

3. The cathode of claim 1, wherein
the first cathode member comprises a first cathode sheet,
the separating member comprises a separator sheet,
the second cathode member comprises a second cathode sheet, and
each of the first and second cathode sheets comprises a current collector and a cathode active material formed on either side of the current collector.

4. The cathode of claim 3, wherein both ends of the stack structure are joined to each other to form a pipe shape.

5. The cathode of claim 3, wherein the stack structure is folded such that both ends of the stack structure are spaced from each other.

6. The cathode of claim 5, wherein the stack structure is folded in a “⊂” or “C” shape.

7. The cathode of claim 1, wherein the current collector comprises at least one selected from among nickel (Ni), copper (Cu) and aluminum (Al).

8. The cathode of claim 1, wherein the cathode active material comprises a carbon-based material.

9. The cathode of claim 1, wherein the separating member comprises at least one selected from among micro glass fibers and long glass fibers.

10. A method of manufacturing a cathode for lithium batteries, the cathode for lithium batteries having a stack structure including a first cathode member, a separating member and a second cathode member stacked in sequence, wherein each of the first and second cathode members comprises a current collector and a cathode active material formed on either side of the current collector.

11. The method of claim 10, comprising:
preparing a first cathode sheet, a separator sheet, and a second cathode sheet;
joining both ends of the first cathode sheet to each other to form a first cathode member having a pipe shape;
attaching the separator sheet to an outer periphery of the first cathode member to form a separating member; and
attaching the second cathode sheet to an outer periphery of the separating member to form a second cathode member,
wherein each of the first and second cathode sheets comprises a current collector and a cathode active material formed on either side of the current collector.

12. The method of claim 10, comprising:
preparing a first cathode sheet, a separator sheet, and a second cathode sheet;
sequentially stacking the separator sheet and the second cathode sheet on the first cathode sheet to form the stack structure; and
joining both ends of the stack structure to form a pipe shape,
wherein each of the first and second cathode sheets comprises a current collector and a cathode active material formed on either side of the current collector.

13. The method of claim 10, wherein the current collector comprises at least one selected from among nickel (Ni), copper (Cu) and aluminum (Al).

14. The method of claim 10, wherein the cathode active material comprises a carbon-based material.

15. The method of claim 10, wherein the separating member comprises at least one selected from among micro glass fibers and long glass fibers.

16. A lithium battery comprising:
a case;
an anode disposed on an inner wall of the case and containing a lithium component;
a separator disposed inside the anode;
a cathode disposed inside the separator;
an anode terminal electrically connected to the anode;
a cathode terminal electrically connected to the cathode; and
an electrolyte filling the case,
wherein the cathode has a stack structure including two cathode members stacked on a separating member interposed therebetween, and each of the cathode members comprises a current collector and a cathode active material formed on either side of the current collector.

17. The lithium battery of claim 16, wherein the cathode has a pipe shape with both ends thereof joined to each other or a folded shape with both ends thereof spaced from each other.

18. The lithium battery of claim 16, wherein the current collector comprises at least one selected from among nickel (Ni), copper (Cu) and aluminum (Al).

19. The lithium battery of claim 16, wherein the cathode active material comprises a carbon-based material.

20. The lithium battery of claim 16, wherein the separating member comprises at least one selected from among micro glass fibers and long glass fibers.
